(19) United States
(12) Patent Application Publication
(10) Pub. No.: US 2010/0118060 A1
(43) Pub. Date: May 13, 2010

(54) PORTABLE ELECTRONIC APPARATUS AND METHOD FOR CONTROLLING LIGHT THEREOF

(75) Inventors: David HUANG, Taoyuan City (TW); Chia-Hsing LIAO, Taoyuan City (TW); Te-Mu CHEN, Taoyuan City (TW); Hsiu-Hung CHOU, Taoyuan City (TW); Hsun-Hsin CHUANG, Taoyuan City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: HIGH TECH COMPUTER CORP., Taoyuan City (TW)

(21) Appl. No.: 12/556,816

(22) Filed: Sep. 10, 2009

(30) Foreign Application Priority Data
Nov. 10, 2008 (TW) 097143393

(51) Int. Cl. G09G 5/10

(52) U.S. Cl. 345/690; 315/291; 315/294

(57) ABSTRACT

A portable electronic apparatus and a method for controlling a light source thereof are provided. The portable electronic apparatus comprises a main control module, a light control module, and a light source module which is configured to generate light. The method comprises the following steps: storing a plurality of light control parameters into the main control module; outputting one of the light control parameters to the light control module by the main control module in response to an input signal; and generating and transmitting a light control signal to the light source module through the light control module in response to the outputted light control parameters. As a result, the brightness of the light generated by the light source module is controlled.

This application claims the benefit of priority based on Taiwan Patent Application No. 097143393, filed on Nov. 10, 2008, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a portable electronic apparatus and a method for controlling light thereof. More particularly, the present invention relates to a portable electronic apparatus having a plurality of sets of light control parameters stored in the memory of a main control module.

2. Descriptions of the Related Art

Portable electronic apparatuses commercially available in the market, such as mobile phones and personal digital assistants (PDAs), are usually equipped with light-emitting diodes (LEDs) of different colors that can flicker according to different events. For example, when a mobile phone is in a standby mode, a green LED thereof will flicker to indicate that the mobile phone is now in the standby mode. In another example, if the mobile phone operates under a low battery status, a red LED thereof will flicker to remind the user to replace or recharge the battery. However, light control parameters, e.g., the flickering frequency and brightness, dictating the flickering modes of LEDs may have preset and unchangeably stored at memory early in the design stage of a portable electronic apparatus. Therefore, as the number of flickering modes in the portable electronic apparatus increases, the capacity of the memory for storing corresponding light control parameters needs to also be increased accordingly, leading to higher manufacturing costs.

Furthermore, as the number of flickering modes increases, it will take more time to find the light control parameters, corresponding to the event occurring, from the memory, making it impossible to adjust the brightness or chromaticity of the LEDs in a real-time manner in response to the event.

As a result, it is important to maintain constant memory capacity of the portable electronic apparatus as the number of light control parameters increase while minimizing the time necessary for switching between different light brightnesses of the LED and even while changing from monochromatic light to color light in the portable electronic apparatus.

### SUMMARY OF THE INVENTION

The invention provides a portable electronic apparatus, which comprises a main control module, a light control module and a light source module. The main control module is configured to receive an input signal, and output a first set of light control parameters according to the input signal. The light control module has a first preload unit which is configured to receive and store the first set of light control parameters outputted from the main control module. The light control module generates a light control signal according to the first set of light control parameters. The light source module is electrically connected to the main control module via the light control module and configured to generate light and receive the light control signal to control the brightness of the light.

This invention also provides a portable electronic apparatus, which comprises a main control module, a light control module and a light source module. The main control module is configured to output a control signal and a plurality of sets of light control parameters. The light control module has a plurality of preload units which are configured to respectively receive and store the sets of light control parameters outputted from the main control module. The light control module selects one of the sets of light control parameters stored in one of the preload units according to the control signal, and generates a light control signal according to the selected one of sets of the light control parameters. The light source module is electrically connected to the main control module via the light control module and has a first color emitting unit and a second color emitting unit. The light source module is configured to generate a mixing light and receive the light control signal to control the brightness of the mixing light.

This invention further provides a method for controlling light of a portable electronic apparatus. The portable electronic apparatus stores a plurality of sets of light control parameters. The method comprises the following steps: receiving an input signal; outputting one of sets of the light control parameters according to the input signal; generating a light control signal according to the outputted one of sets of light control parameters; and controlling the brightness of the light according to the light control signal.

According to the above descriptions, the various sets of light control parameters are pre-stored in a memory of the main control module, and the set of light control parameters is transmitted to the light control module for the light control module to generate a light control signal for controlling the light source module. Meanwhile, the present invention further transmits and stores the sets of light control parameters that are frequently used into the preload unit of the light control module. In this way, the capacity of the memory in the light control module is reduced, and the overall time of switching between the brightnesses of the light source module is further shortened.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic outside view of the portable electronic apparatus of the present invention;

FIG. 2 is a circuit block diagram of the portable electronic apparatus of the present invention;

FIG. 3 is a light waveform diagram of the light source module in the portable electronic apparatus of the present invention;

FIG. 4 is another schematic outside view of the portable electronic apparatus of the present invention;

FIG. 5 is a flowchart illustrating how the portable electronic apparatus of the present invention controls the light brightness;

FIG. 6 is a flowchart illustrating how the light control signal is generated;

FIG. 7 is a flowchart illustrating how the light brightness is controlled according to the light control signal; and

FIG. 8 is a circuit block diagram of another portable electronic apparatus of the present invention.

### DESCRIPTION OF THE PREFERRED EMBODIMENT

In the following descriptions, this invention will be explained with reference to the embodiments thereof. However, these embodiments are not intended to limit this invention to any specific environment, applications or particular implementations described in these embodiments. Therefore, descriptions of these embodiments are only for purposes of illustration rather than limitation of this invention. In the following embodiments and the attached drawings, elements unrelated to this invention are omitted from depiction.

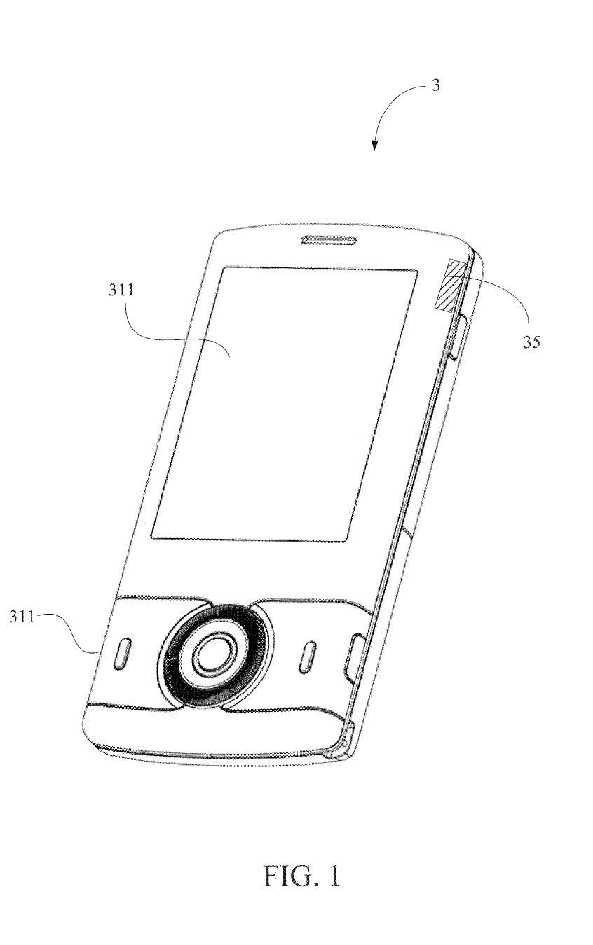

FIG. 1 shows an outside view of a portable electronic apparatus 3 according to one embodiment of the present invention. The portable electronic apparatus 3 refers generally to apparatuses that are portable in use, including but not limited to mobile phones, notebook computers, personal digital assistants (PDAs), satellite navigation devices and the like. For purposes of illustration, a mobile phone will be described as an example of the portable electronic apparatus 3 in this embodiment. The portable electronic apparatus 3 depicted in FIG. 1 has an input unit 311 and a light source module 35. The input unit 311 may be a keypad, a touch screen or some other input device for a user to input instructions. The light source module 35 uses light emitting diodes (LEDs) to generate light, although this invention is not merely limited thereto.

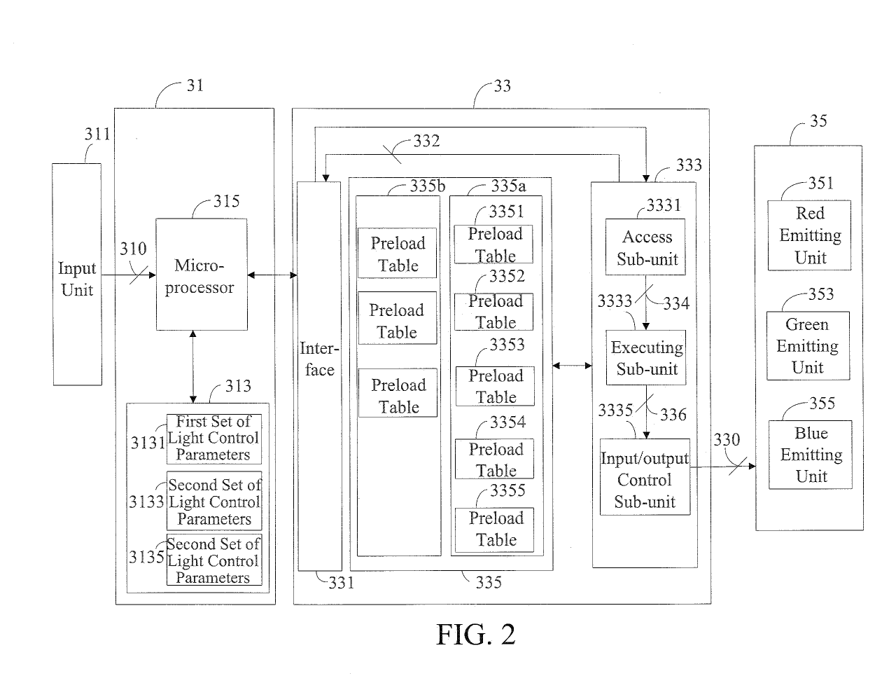

FIG. 2 illustrates a circuit block diagram of the portable electronic apparatus 3 of the present invention. The portable electronic apparatus 3 comprises a main control module 31, a light control module 33 and a light source module 35. The main control module 31 is electrically connected to an input unit 311 and comprises a memory 313 and a microprocessor 315. The input unit 311 is adapted to generate an input signal 310 according to an instruction inputted by the user. The memory 313 stores a plurality of sets of light control parameter. For purposes of simplicity, only a first set of light control parameters 3131 and second sets of light control parameters 3133, 3135 are illustrated in this embodiment. The microprocessor 315 receives the input signal 310 from the input unit 311 and, after processing the input signal 310, selects and retrieves light control parameters corresponding to the input signal 310 from the memory 313 for being outputted. In this embodiment, the light control parameters corresponding to the input signal 310 are the first set of light control parameters 3131. Thus, after receiving the input signal 310, the microprocessor 315 selects and retrieves the first set of light control parameters 3131 from the memory 313 for being outputted. In other embodiments, the input signal 310 may be generated by other events, for example, an incoming call, a dead battery or an alert event, rather than being limited to be generated by the input unit 311.

The light control module 33 comprises an interface 331, a control unit 333 and a preload bank 335. The interface 331 may be an I²C bus, a universal serial bus (USB), an IEEE 1394 bus or a serial peripheral interface (SPI). Through the interface 331, the first set of light control parameters 3131 outputted from the microprocessor 315 of the main control module 31 can be received by the light control module 33. After receiving the first set of light control parameters 3131, the control unit 333 generates a light control signal 330 and a preload signal 332 according to the received first set of light control parameters 3131. The preload bank 335 comprises a first preload unit 335a and a second preload unit 335b. It should be noted that the present invention has no limitation on the number of preload units included in the preload bank 335, and the two preload units included in the preload bank 335 of this embodiment are only for purposes of illustration rather than limitation of the present invention.

After receiving the first set of light control parameters 3131, the light control module 33 will store it into the first preload unit 335a. The above description involves operations of the main control module 31 transmitting the first set of light control parameters 3131 to the light control module 33. However, after the first set of light control parameters 3131 is transmitted to the light control module 33, the preload signal 332 generated by the light control module 33 will be transmitted to the microprocessor 315 of the main control module 31 so that in response to the preload signal 332, the microprocessor 315 of the main control module 31 can transmit one of the second sets of light control parameters 3133, 3135 from the memory 313 to the light control module 33 and store it into the preload bank 335 via the control unit 333 of the control module 33.

The control unit 333 of the light control module 33 further comprises an access sub-unit 3331, an executing sub-unit 3333 and an input/output control sub-unit 3335. The access sub-unit 3331 is configured to receive the aforesaid first set of light control parameters 3131 and generate an access instruction 334 according to the first set of light control parameters 3131. The executing sub-unit 3333 is configured to execute the access instruction 334 and output a driving signal 336. The input/output control sub-unit 3335 is configured to receive and process the driving signal 336 and then output the light control signal 330 to the light source module 35.

The light source module 35 consists of a red light emitting unit 351, a green light emitting unit 353 and a blue light emitting unit 355. More specifically, each of these light emitting units may be an LED, in which the red LED is adapted to generate red light, the green LED is adapted to generate green light and the blue LED is adapted to generate blue light. The light source module 35 may generate light of a certain brightness level by mixing the light of the aforesaid three primary colors (i.e. red, green, and blue). Each of the aforesaid light control parameter sets 3131, 3133, 3135 includes red data, green data and blue data. The control unit 333 of the light control module 33 generates the light control signal 330 according to the red, green and blue data of the first set of light control parameters 3131. Then, the light control signal 330 controls the brightness of the light from the red light emitting unit 351 according to the red data of the first set of light control parameters 3131, the brightness of the light from the green light emitting unit 353 according to the green data of the first set of light control parameters 3131, and the brightness of the light from the blue light emitting unit 355 according to the blue data of the first set of light control parameters 3131. Thus, the brightness of the light from the light source module 35 can be controlled by adjusting the brightness of the red light, the green light and the blue light respectively.

More specifically, after the microprocessor 315 of the main control module 31 receives the input signal 310 via the interface 311, the microprocessor 315 selects and retrieves the first set of light control parameters 3131, which further comprises a standby mode control parameter, from the memory 313 according to the input signal 310. The microprocessor 315 then transmits the first set of light control parameters 3131 to the interface 331 of the light control module 33. The first set of light control parameters 3131 includes red, green and blue data; the configuration of which will be detailed later. After receiving the first set of light control parameters 3131, the interface 331 then transmits the first set of light control parameters 3131 to the control unit 333 which then programs and stores the red, green and blue data of the first set of light control parameters 3131 into the first preload unit 335a respectively. In this embodiment, the first preload unit 335a has five pre-configured preload tables 3351, 3352, 3353, 3354 and 3355. The red, green and blue data of the first set of light control parameters 3131 are stored into the preload table 3351. Meanwhile, the control unit 333 outputs the light control signal 330 to the light source module 35 so that the light source module 35 can control the brightness of the light according to the first set of light control parameters 3131 (i.e. comprising a standby mode control parameter).

While the control unit 333 outputs the light control signal 330 to the light source module 35, the control unit 333 also transmits the preload signal 332 to the microprocessor 315 of the main control module 31. In response to the preload signal 332, the microprocessor 315 transmits the second set of light control parameters 3133 (e.g. comprising an incoming call mode control parameter) or the other second set of light control parameters 3135 (e.g. comprising a dead battery mode control parameter) stored in the memory 313 to the light control module 33, and stores the red, green and blue data of the second sets of light control parameters 3133, 3135 into the preload tables of the second preload unit 335b in the aforesaid sequence respectively. Thus, both the second set of light control parameters 3133 (i.e. comprising an incoming call mode control parameter) and the other second set of light control parameters 3135 (i.e. comprising a dead battery mode control parameter) are stored into the second preload unit 335b of the light control module 33 in advance. Therefore, when the light source module 35 of the portable electronic apparatus 3 is controlling the brightness of light according to the first set of light control parameters 3131 (i.e. comprising the standby mode control parameter), if there is an incoming call to cause the light source module 35 to be switched to use the second set of light control parameters 3133 (i.e. comprising an incoming call mode control parameter), the control unit 333 may access the red, green and blue data of the second set of light control parameters 3133 directly from the second preload unit 335b so that the light brightness of the light source module 35 can be switched promptly to shorten the time necessary for light brightness control. The above embodiment is only provided to illustrate an example of and explain the technical features of this invention, but not to limit the scope of this invention.

Herein, it should be appreciated that although the second sets of light control parameters 3133, 3135 are stored into the second preload unit 335b in this preferred embodiment, the second sets of light control parameters 3133, 3135 outputted by the main control module 31 may also be stored into the first preload unit 335a apart from the second preload unit 335b. The present invention does not limit which preload unit of the preload bank 335 the sets of light control parameters will be stored in. That is, the second sets of light control parameters 3133, 3135 may be stored into a preload table of either the first preload unit 335a or the second preload unit 335b according to the preload signal 332.

Additionally, in other embodiments where the portable electronic apparatus 3 has a sliding mechanism or has an extendable and retractable keypad, the first set of light control parameters 3131 stored in the memory 313 is adapted to drive the light source module 35 to generate a flickering light corresponding to the extending action of the keypad, while the second set of light control parameters 313 stored in the memory 313 is adapted to drive the light source module 35 to generate another flickering light corresponding to the retracting action of the keypad. The switching between the brightnesses corresponding to the keypad extending and retracting actions, as well as the operational relationships between the control unit 333 and the preload bank 335 of the light control module 33 and the main control module 31 have been described above and thus will not be further described herein.

For modulation of the chromaticity and brightness of the light, the pulse width modulation (PWM) is adopted. Because the PWM is well known in the art, the description of the modulation will be made only briefly herein.

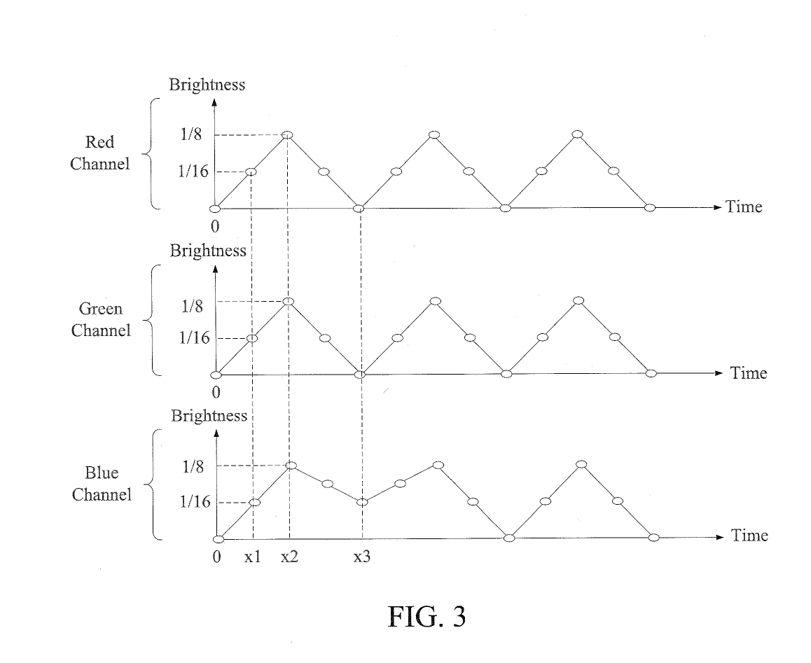

FIG. 3 illustrates a brightness waveform diagram of the light source module 35 in the portable electronic apparatus 3 of the present invention. From top to bottom, FIG. 3 shows a waveform of the red light channel, a waveform of the green light channel and a waveform of the blue light channel of the light source module 35, respectively. More specifically, for the red light channel, coordinates (x, y) may be used to represent the brightness exhibited by the red light channel at individual time points, in which the horizontal axis (x) represents time and the longitudinal axis (y) represents the brightness exhibited by the red light emitting unit 351 of the light source module 35 through PWM. For example, for an 8-bit system, the red light channel has 256 different color levels, each of which has corresponding brightness. A lower brightness represents a lower color level. In other words, a longitudinal coordinate of 0/256 represents a fully dark state, i.e., a state in which the PWM is completely OFF. On the other hand, a higher brightness represents a higher color level. In other words, a longitudinal coordinate of 256/256 represents a fully bright state, i.e., a state in which the PWM is completely ON. Because the PWM is a conventional technology and those of ordinary skill in the art will readily appreciate how the PWM operates, no further description will be made herein.

For example, the red light channel has a brightness value of 0 at the time point 0, the label is (0, 0) which represents a fully dark state of the red light. When the red, green and blue light channels all have a brightness value of 0, the brightness state of the mixed light will be fully dark. At time point x1, the red light channel has a brightness value of 16, so the label is (x1, 16/256), i.e., (x1, 1/16), which represents that the brightness of the red light is one sixteenth of the brightness when the PWM is completely ON. At time point x2, the red light channel has a brightness value of 32, so the label is (x1, 32/256), i.e., (x1, ⅛), which represents that the brightness of the red light is one eighth of the brightness when the PWM is completely ON. The process will continue until the red, green and blue light channels all have their brightness represented by different coordinates (x, y) at different time points. Then, at time point x3, the red light channel, the green light channel and the blue light channel have a brightness value of (x3, 0), (x3, 0) and (x3, 1/16) respectively, so the mixed light is blue with a sixteenth of a brightness thereof when the PWM is completely ON. In this way, the light brightness of the light source module 35 can be controlled, and the chromaticity of the light can also be altered accordingly.

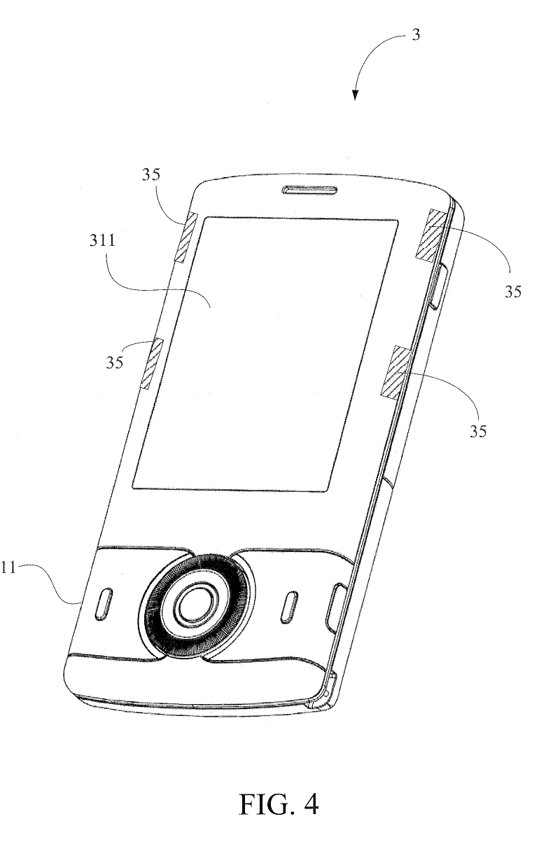

Although the operations and actions of only a single light source module 35 are described in this embodiment, this invention has no limitation on the number of light source modules 35. Operations using a plurality of light source modules 35 (as shown in FIG. 4) will be readily appreciated by those of ordinary skill in the art upon reviewing the above description and thus will not be further described herein.

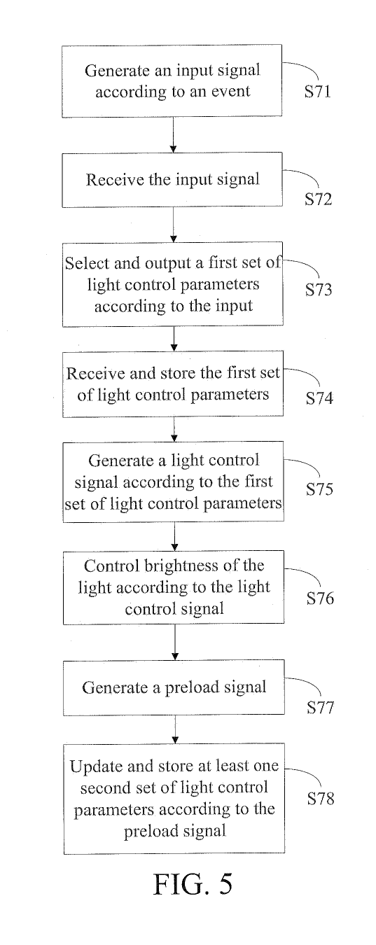

A flowchart of the aforesaid process for controlling light brightness of the light source module 35 in the portable electronic apparatus 3 is depicted in FIG. 5. The portable electronic apparatus 3 is adapted to store a plurality of sets of light control parameters, including a first set of light control parameter and at least one second set of light control parameter. However, the number of light control parameters is not limited to three sets, and the three sets of light control parameters of this embodiment are provided only for illustration purposes. The light of the light source module 35 is generated by mixing red light, green light and blue light. The method comprises the following steps. Initially, step S71 is executed to generate an input signal according to an event. Next, step S72 is executed to receive the input signal. Then, step S73 is executed to select and output a first set of light control parameters according to the input signal.

Afterwards, step S74 is executed to receive and store the first set of light control parameters. Step S75 is executed to generate a light control signal according to the first set of light control parameters. Thereafter, step S76 is executed to control the brightness of the light according to the light control signal, and step S77 is executed to generate a preload signal. Finally, step S78 is executed to update and store at least one second set of light control parameters according to the preload signal.

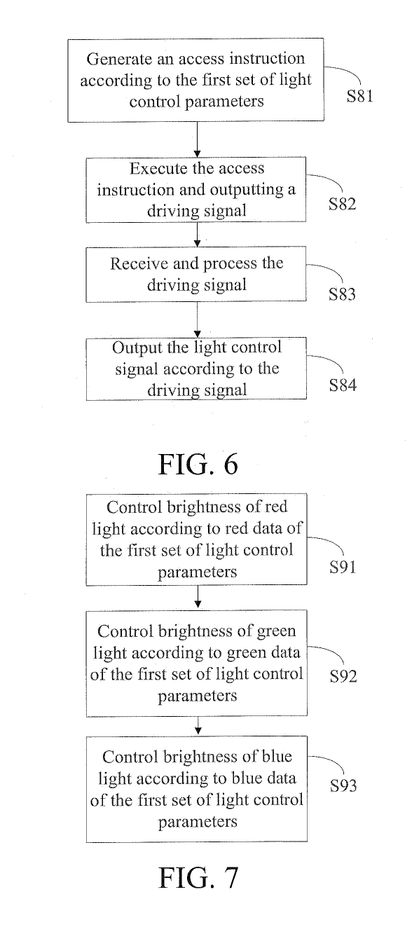

FIG. 6 depicts a flowchart of the process of generating the light control signal in step S75. Initially, step S81 is executed to generate an access instruction according to the first set of light control parameters. Next, step S82 is executed to execute the access instruction and output a drive signal. Then, step S83 is executed to receive and process the driving signal. Finally, step S84 is executed to output a light control signal according to the driving signal.

FIG. 7 depicts a flowchart of the process of controlling brightness of the light in step S76. Initially, step S91 is executed to control the brightness of the red light according to the red data of the first set of light control parameters. Next, step S92 is executed to control brightness of the green light according to the green data of the first set of light control parameters. Finally, step S93 is executed to control the brightness of the blue light according to the blue data of the first set of light control parameters.

In addition to the aforesaid steps, the process of controlling the light brightness of the light source module 35 can also execute all the operations and functions set forth above with respect to the portable electronic apparatus 3 of the present invention. The methods in which the processes of FIGS. 5-7 execute these operations and functions will be readily appreciated by those of ordinary skill in the art based on the explanation of the portable electronic apparatus 3 of this invention, and thus will not be further described herein.

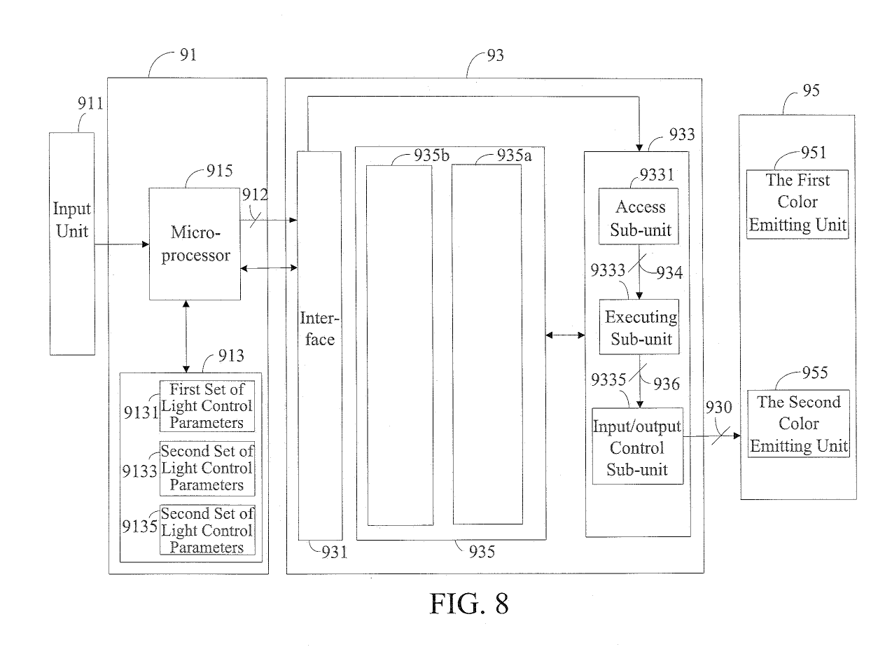

Another preferred embodiment of this invention is depicted in FIG. 8, which is another circuit block diagram of the portable electronic apparatus 3 of this invention. The circuit block diagram comprises a main control module 91, a light control module 93 and a light source module 95. The main control module 91 comprises a memory 913 and a microprocessor 915. The memory 913 is configured to store a plurality of sets of light control parameters 9131, 9133, 9135. A microprocessor 915 is electrically connected to the memory 913 and configured to select the plurality of sets of light control parameters 9131, 9133, 9135 from the memory 913 and then output them and a control signal 912 to the light control module 93.

The light control module 93 comprises an interface 931, a plurality of preload units 935a, 935b and a control unit 933. For purposes of simplicity, the plurality of preload units are represented by only a first preload unit 935a and a second preload unit 935b herein. The aforesaid plurality of sets of light control parameters 9131, 9133, 9135 are transmitted via the interface 931, which may be an I²C bus, a USB, an IEEE 1394 bus or an SPI.

The first preload unit 935a and the second preload unit 935b receive and store the sets of light control parameters 9131, 9133, 9135 outputted by the main control module 91 respectively. The light control module 93 is configured to select one of the sets of light control parameters 9131, 9133, 9135 stored in the first preload unit 935a or the second preload unit 935b according to the control signal 912 transmitted by the microprocessor 915. Meanwhile, the light control module 93 generates a light control signal 930 in the control unit 933 according to the selected set of light control parameters. The control unit 933 comprises an access sub-unit 9331, an executing sub-unit 9333 and an input/output control sub-unit 9335. After receiving one of sets of light control parameters 9131, 9133, 9135, the access sub-unit 9331 generates and transmits an access instruction 934 to the executing sub-unit 9333. Then, the executing sub-unit 9333 executes the access instruction 934 and outputs a driving signal 936. The input/output control sub-unit 9335 receives and processes the driving signal 936 and then outputs the light control signal 930 according to the result of processing the processed driving signal 936.

The light source module 95 is electrically connected to the light control module 93 and has a first color emitting unit 951 and a second color emitting unit 955 for generating mixed light. The light source module 95 receives the light control signal 930 and controls the brightness of the mixed light according to the light control signal 930. It should be noted that the first color emitting unit 951 and second color emitting unit 955 may be LEDs of different colors. For example, the first color emitting unit 951 may be a red LED, while the second color emitting unit 955 may be a blue LED. Alternatively, the first color emitting unit 951 may be a green LED, while the second color emitting unit 955 may be a red LED.

This embodiment only makes a slight modification on the internal arrangement of the portable electronic apparatus, with operations of transmitting the sets of light control parameters 9131, 9133, 9135 among the main control module 91, the light control module 93 and the light source module 95 as well as functions thereof remaining the same as those in the preferred embodiment shown in FIG. 2. Thus, no further description will be made herein.

According to the above descriptions, this present invention provides a portable electronic apparatus and a method for controlling light thereof. Furthermore, by storing a plurality of light control parameters into the main control module, and storing selected light control parameters that are used or frequently used into the preload units of the light control module, the necessary capacity of the memory in the light control module is reduced and the adjustment time necessary for controlling the light brightness is further shortened.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A portable electronic apparatus, comprising:
a main control module configured to receive an input signal and to output a first set of light control parameters according to the input signal;
a light control module having a first preload unit and being electrically connected to the main control module, the first preload unit configured to receive and store the first set of light control parameters outputted from the main control module, wherein the light control module generates a light control signal according to the first set of light control parameters; and
a light source module electrically connected to the light control module and configured to generate light and to receive the light control signal to control brightness of the light.

2. The portable electronic apparatus as claimed in claim 1, wherein the main control module further comprises:
a memory configured to store the first set of light control parameters and at least one second set of light control parameters; and
a microprocessor electrically connected to the memory and configured to select and retrieve the first set of light control parameters from the memory after receiving the input signal.

3. The portable electronic apparatus as claimed in claim 2, the light control module further comprises:
a control unit configured to receive the first set of light control parameters outputted from the main control module and to generate the light control signal and a preload signal according to the first set of light control parameters; and
a second preload unit configured to receive and store the at least one second set of light control parameters outputted from the memory;
wherein the preload signal is outputted from the control unit to the main control module, and the main control module transmits the at least one second set of light control parameters to be stored to the second preload unit in response to the preload signal.

4. The portable electronic apparatus as claimed in claim 3, wherein the light control module further comprises an interface, the first set of light control parameters, the at least one second set of light control parameters and the preload signal are transmitted via the interface, the interface is one of an I²C bus, an universal serial bus (USB), an IEEE 1394 bus and a serial peripheral interface (SPI).

5. The portable electronic apparatus as claimed in claim 3, wherein the control unit further comprises:
an access sub-unit configured to receive the first set of light control parameters outputted from the main control module and to generate an access instruction according to the first set of light control parameters;
an executing sub-unit configured to execute the access instruction and to output a driving signal; and
an input/output control sub-unit configured to receive the driving signal and to output the light control signal according to the driving signal to control the brightness of the light.

6. The portable electronic apparatus as claimed in claim 1, wherein the light source module comprises a red emitting unit, a green emitting unit, and a blue emitting unit, the red emitting unit is configured to generate red light, the green emitting unit is configured to generate green light, the blue emitting unit is configured to generate blue light, and the light is formed by mixing the red light, the green light and the blue light.

7. The portable electronic apparatus as claimed in claim 6, wherein the first set of light control parameters includes red data, green data and blue data, and the light control signal controls brightness of the red light according to the red data, brightness of the green light according to the green data, and brightness of the blue light according to the blue data.

8. A portable electronic apparatus, comprising:
a main control module configured to output a control signal and a plurality of sets of light control parameters;
a light control module having a plurality of preload units configured to respectively receive and store the sets of light control parameters outputted from the main control module, wherein the light control module selects one of the sets of light control parameters stored in one of the preload units according to the control signal, and generates a light control signal according to the selected one of sets of the light control parameters; and
a light source module being electrically connected to the light control module and having a first color emitting unit and a second color emitting unit for generating a mixing light, the light source module configured to receive the light control signal to control brightness of the mixing light.

9. The portable electronic apparatus as claimed in claim 8, wherein the main control module further comprises:
a memory configured to store the sets of light control parameters; and
a microprocessor electrically connected to the memory and configured to select and retrieve the sets of light control parameters from the memory.

10. The portable electronic apparatus as claimed in claim 8, wherein the light control module further comprises an interface, the sets of light control parameters are transmitted via the interface, the interface is one of an I²C bus, an USB, an IEEE 1394 bus and an SPI.

11. A method for controlling light of a portable electronic apparatus, comprising:
receiving an input signal;
outputting a first set of light control parameters according to the input signal;
storing the first set of light control parameters to a preload unit;
generating a light control signal according to the first set of light control parameters; and
controlling brightness of the light according to the light control signal.

12. The method as claimed in claim 11, further comprising:
generating a preload signal; and
storing at least one second set of light control parameters to a second preload unit in response to the preload signal.

13. The method as claimed in claim 11, wherein the step of generating the light control signal further comprises:
generating an access instruction according to the first set of light control parameters;
executing the access instruction and outputting a driving signal;
receiving the driving signal; and
outputting the light control signal according to the driving signal to control the brightness of the light.

14. The method as claimed in claim 11, wherein the light is formed by mixing red light, green light and blue light, the first set of light control parameters includes red data, green data and blue data, and the step of controlling the brightness of the light further comprises:
controlling brightness of the red light according to the red data;
controlling brightness of the green light according to the green data; and
controlling brightness of the blue light according to the blue data.
